(19) United States
(12) Patent Application Publication
(10) Pub. No.: US 2005/0099821 A1
(43) Pub. Date: May 12, 2005

(54) System for visually aiding a vehicle driver's depth perception

(75) Inventors: Brant J. Potter, Columbus, IN (US); Robert L. King, Seymour, IN (US)

Correspondence Address: OSRAM SYLVANIA INC, 100 ENDICOTT STREET, DANVERS, MA, 01923, US

(73) Assignee: Valeo Sylvania LLC., Seymour, IN (US)

(21) Appl. No.: 10/998,309

(22) Filed: Nov. 24, 2004

(51) Int. Cl. B60Q 1/00

(52) U.S. Cl. 362/548; 362/459

(57) ABSTRACT

A system for visually aiding a vehicle driver's depth perception includes a headlamp assembly mounted on a forward portion of the vehicle, first and second beam projectors mounted in the headlamp assembly, the first beam projector being adapted to project a first beam in a plane and parallel to a lengthwise axis of the vehicle, and the second beam projector being adapted to project a second beam in the plane and in a direction intersecting the first beam. The beam projectors are separated in the headlamp assembly by a selected distance and the second beam projector is disposed such that the second beam intersects the first beam in the plane at a selected angle, whereby the beam intersection provides a unitary beam pattern on a surface transverse to the plane at a selected distance forward of the vehicle.

### BACKGROUND OF THE INVENTION

1. Field of the Invention

This invention relates to an optical system for a vehicle which assists a driver of the vehicle to properly position the vehicle in relation to an object forward of the vehicle, such as a wall or other structure, or another vehicle.

2. Description of the Prior Art

It is known to provide a vehicle parking position indicator which informs a vehicle driver of the desired positioning of the forward end of the vehicle relative to a garage wall, or the like.

In U.S. Pat. No. 5,177,479, issued Jan. 5, 1993 to John B. Cotton, there is described a garage parking position indicator operable to indicate the desired positioning of the forward and rear edges of the vehicle between the rear wall of the garage and the garage door. The system includes an infrared transmitter and an infrared receiver mounted, respectively, on opposite sides of the garage access door. The transmitter continuously transmits and directs wave energy toward the receiver, such that the presence of any portion of the vehicle between the transmitter and the receiver interrupts reception of the wave energy by the receiver. A light signal device is operated in response to the reception of the wave energy.

In U.S. Pat. No. 6,184,800, issued Feb. 6, 2001, to Homer B. Lewis, there is described a visual automobile parking aid which includes a battery powered laser projector supported by a mounting bracket. The bracket is adapted for removable attachment to the interior of the vehicle windshield. The laser is projected forwardly from the vehicle to display an image on a wall surface in front of the vehicle. As the vehicle moves forwardly, the image travels down the wall toward a previously marked location on the wall. When the image coincides with the marked location, the vehicle has reached the preferred parking position.

In U.S. Pat. No. 6,040,787, issued Mar. 21, 2000 to Lamogne W. Durham, there is shown and described a laser vehicle parking apparatus which includes a housing adapted for attachment to a vehicle windshield visor. Mounted in the housing are battery powered means for projecting two light beams. The beams converge in an area forward of the vehicle. The distance at which the beams converge on a wall forward of the vehicle is a selected safe distance for the positioning of the vehicle forward end relative to the wall. The angle of at least one of the beams is adjustable, so that the distance between the vehicle and the wall at which the beams converge is selectable.

It has been determined that such systems have not met with wide acceptance because of the add-on nature of the systems. They require apparatus to be mounted on the vehicle and/or the garage in which the vehicle is customarily parked. Further, they require a self-contained power source and/or an off-on switch.

It is believed that while such systems could be helpful, in order to be widely accepted they must be original equipment, that is, an integral part of the vehicle, powered by the vehicle, and essentially automatic in operation.

### SUMMARY OF THE INVENTION

The object of the invention is, therefore, the provision of a system for visually aiding a vehicle driver's depth perception with respect to a wall or other structure defining the forward boundary of a parking location.

With the above and other objects in view, a feature of the present invention is the provision of a system for visually aiding a vehicle driver's depth perception. The system includes a headlamp assembly mounted on a forward portion of the vehicle, and first and second beam projectors mounted in the headlamp assembly. The first beam projector is adapted to project a first beam in a plane and parallel to a lengthwise axis of the vehicle. A second beam projector is adapted to project a second beam in the plane and in a direction intersecting the first beam. The beam projectors are separated in the headlamp assembly by a selected distance and the second beam projector is disposed such that the second beam intersects the first beam in the plane at a selected angle. The beam intersection provides a unitary beam pattern on a surface transverse to the plane at a selected distance forward of the vehicle.

The above and other features of the invention, including various novel details of construction and combinations of parts, will now be more particularly described with reference to the accompanying drawings and pointed out in the claims. It will be understood that the particular devices embodying the invention are shown by way of illustration only and not as limitations of the invention. The principles and features of this invention may be employed in various and numerous embodiments without departing from the scope of the invention.

### BRIEF DESCRIPTION OF THE DRAWINGS

Reference is made to the accompanying drawings in which are shown illustrative embodiments of the invention, from which its novel features and advantages will be apparent.

In the drawings:

FIG. 1 is a elevational diagrammatic view of a vehicle approaching a parking location defined in part by a wall;

FIG. 2 is a top plan diagrammatic view thereof;

FIG. 3 is a front elevational view of the wall of FIGS. 1 and 2, showing projected light images on the wall as the vehicle approaches the wall at a selected distance from the wall;

FIG. 4 is similar to FIG. 3, but shows the images of FIG. 3 superimposed upon one another at the selected distance;

FIGS. 5-7 are diagrammatic illustrations of alternative light beam projecting arrangements;

FIGS. 8 and 9 are perspective views of a vehicle headlamp reflector, showing an alternative embodiment of the invention;

FIG. 10 is a diagrammatic depiction of left and right high beam images on a wall 1.5 meters from the front of a vehicle approaching the wall, and, in addition, above the high beam images, images projected by the system of FIGS. 9 and 10; and

FIG. 11 is similar FIG. 10, but shows the images projected by the system of FIGS. 8 and 9 merged into a single image 1.0 meter from the front of the vehicle, which is a typical selected distance.

### DESCRIPTION OF THE PREFERRED EMBODIMENT

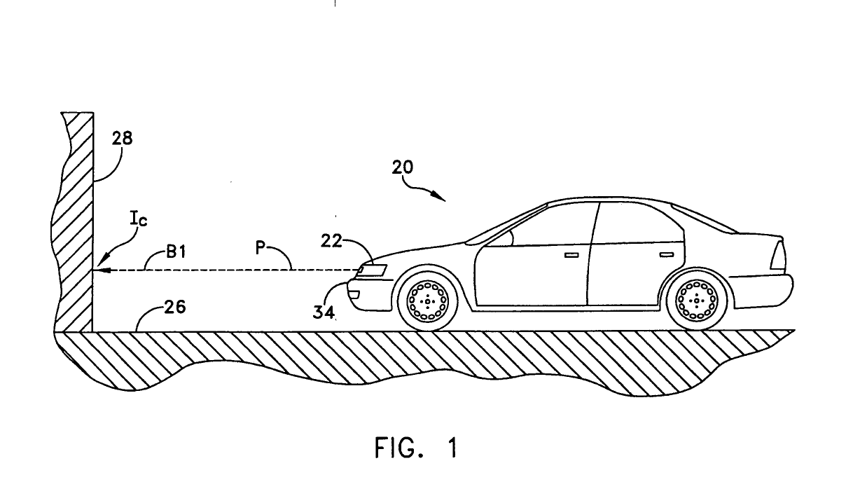

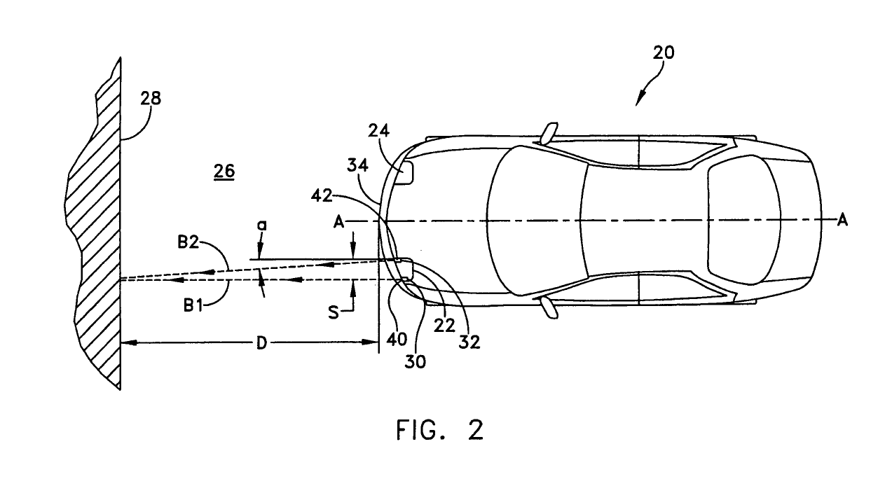

Referring to FIGS. 1 and 2, it will be seen that the system is mounted in a vehicle 20 having a left headlamp 22 and a right headlamp 24. The vehicle 20 is shown in FIGS. 1 and 2 moving on a surface 26, such as the surface of a garage, a driveway, a parking lot, or the like, approaching an upstanding wall 28.

One of the headlamps, left headlamp 22 for example, is provided with beam projectors 30, 32 which are adapted to direct images onto the wall 28. The first beam projector 30 is adapted to project a first beam B1 in a plane P and parallel to a lengthwise axis A-A of the vehicle 20.

The second beam projector 32 is adapted to project a second beam B2 in the plane P and angled in a direction intersecting the first beam B1 (FIG. 2) at a selected distance D between the front end 34 of the vehicle 20 and the wall 28.

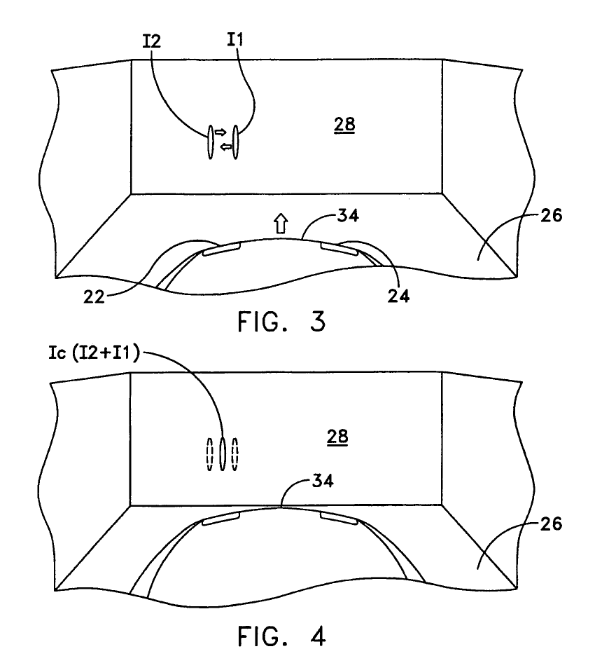

As the vehicle 20 approaches the wall 28 the first and second beams B1, B2 cast images I1 and I2 on the surface of the wall 28 (FIG. 3). When the front end 34 of the vehicle 20 draws closer to the wall 28, and reaches the distance D from the wall, the light images I1 and I2 merge to form a composite image Ic (FIG. 4). The distance D is determined by the distance of separation S of the beam projectors 30, 32 and the angle a of beam B2 relative to the beam B1. The second beam projector 32 may be movable to provide driver-operated selectivity in manual adjustment of the angle a. It will be apparent that the configuration of the discrete images I1 and I2, as well as the composite image Ic may be of any selected configuration, though the composite image Ic is necessarily dictated by the configuration of the images I1 and I2.

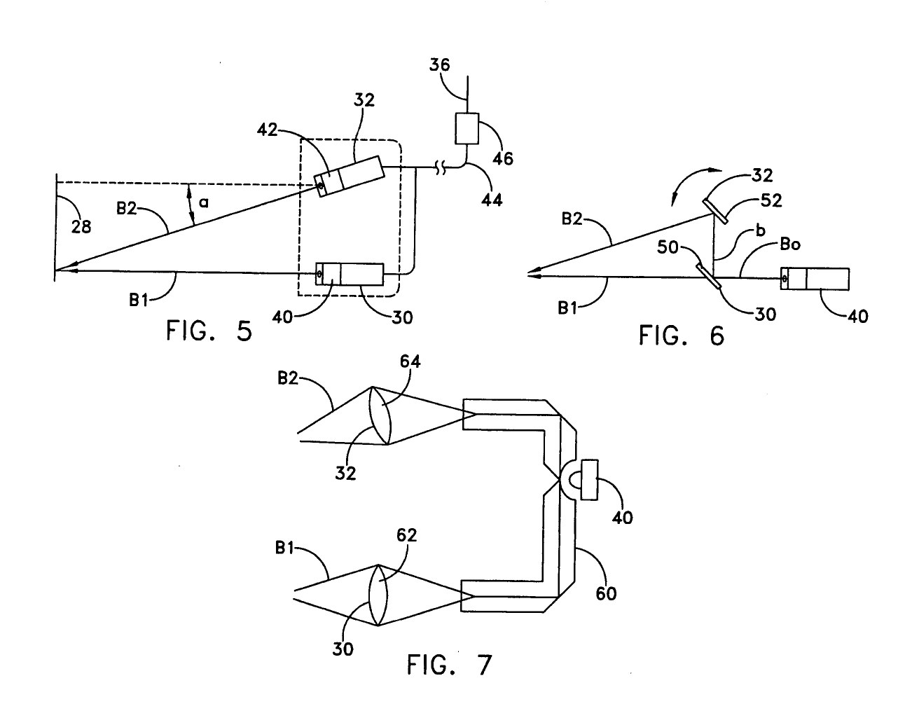

The beam projectors 30, 32 may be first and second laser diodes or LEDs 40,42 in communication with an onboard power source 36 by way of a power line 44 having a switch 46 therein (FIG. 5). Laser diodes provide the advantages of casting small, bright, precise patterns. LEDs generally form larger, less defined patterns, but are of substantially lower cost. Laser diodes are available providing many different patterns of images.

Alternatively, the first and second beam projectors 30, 32 may take the form of a beam splitter 50 (FIG. 6) for receiving a beam Bo from a single laser diode or LED 40, passing a portion of the beam Bo therethrough for establishing the first beam B1, and splitting off a second portion b of the received beam Bo which is directed by a mirror 52 to provide the second beam B2 angled toward the first beam B1.

In a further alternative embodiment, a single laser diode or LED 40 is used in conjunction with a dual path light guide 60 having first and second lenses 62, 64 which serve to project the beams B1 and B2 (FIG. 7).

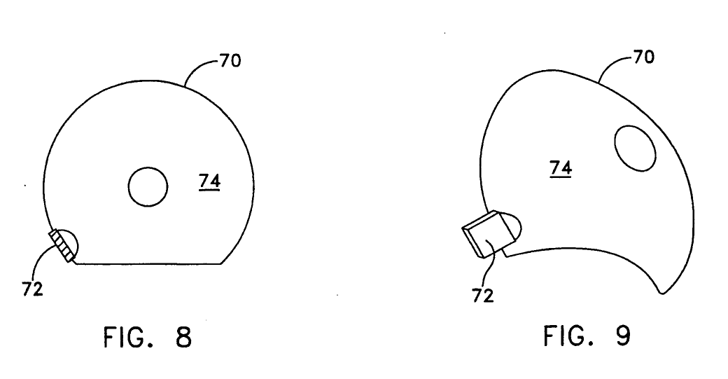

Referring to FIGS. 8 and 9, it will seen that in another alternative embodiment, each of the headlamps 22, 24 is provided with a high beam reflector 70 having a discrete facet 72 fixed to the usual high beam reflector portion 74. The facets 72 receive light from laser diodes or LEDs and operate to project beams B1 and B2 onto the wall 28 in the same manner as described hereinabove.

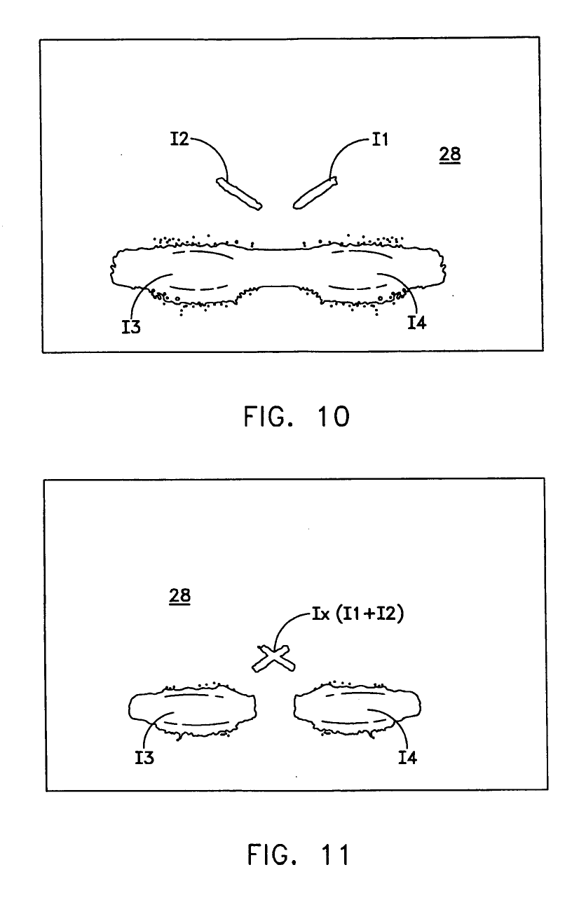

In this embodiment, whenever the high beams are turned on, the depth perception system is automatically placed in operation. The images I1 and I2 cast by the reflector facets 72 preferably are cast above the headlamp high beam images I4 and I3, respectively (FIG. 10). When the front end 34 of the vehicle 20 reaches a position removed from the wall 28 by the distance D, the images I1 and I2 converge upon each other to produce a composite image Ix (FIG. 11). At this point, a driver of the vehicle 20 observes that the vehicle front end 34 is distance D from the wall 28.

The facets 72 can be movable to provide adjustments by a driver to change the distance D at which the images Ic and I2 converge.

An alternative feature of the high beam embodiment includes a switch, such as the switch 46, or a separate switch, which is open at travel and high speeds and closes to activate the system only at low speeds, i.e., at typical parking speeds. Thus, high beams on a highway would not activate the parking system, but high beams pulling into a garage would activate the system.

It is believed that as an original equipment feature for vehicles, the systems presented herein would add very little to the cost of a vehicle, whereas the add-on systems currently available can be somewhat expensive as well as inconvenient.

There is thus provided a system which visually aids a vehicle driver in depth perception in parking situations, which system need not be added to the vehicle or a garage structure, but is an integral part of the vehicle and operated either automatically or by a dashboard switch, or the like.

It will be understood that many additional changes in the details, materials, and arrangement of parts, which have been herein described and illustrated in order to explain the nature of the invention, may be made by those skilled in the art within the principles and scope of the invention as expressed in the appended claims.

1. A system for visually aiding a vehicle driver's depth perception, the system comprising:
a headlamp assembly mounted on a forward portion of the vehicle;
first and second beam projectors mounted in said headlamp assembly;
said first beam projector being adapted to project a first beam in a plane and parallel to a lengthwise axis of the vehicle; and
said second beam projector being adapted to project a second beam in the plane and in a direction intersecting the first beam;
said beam projectors being separated in said headlamp assembly by a selected distance and said second beam projector being disposed such that the second beam intersects said first beam in the plane at a selected angle;
whereby the beam intersection provides a unitary beam pattern on a surface transverse to the plane at a selected distance forward of the vehicle.

2. The system in accordance with claim 1 wherein said headlamp assembly comprises a single headlamp and said first and second beam projectors are mounted in said single headlamp.

3. The system in accordance with claim 2 wherein the system further comprises a switch means for activating and deactivating said projectors.

4. The system in accordance with claim 2 wherein said projectors are a selected one of laser diodes and LEDs, and a lens portion of said headlamp transmits the light beams of the projectors forwardly so as to provide the selected angle of beam intersection and thereby the selected distance to the beam intersection.

5. The system in accordance with claim 2 wherein said projectors comprise a beam splitter for providing said first beam and directing a beam to a mirror, the mirror being adapted to project the second beam at the selected angle, and a single light source for providing a single beam to said beam splitter, said light source being a selected one of a laser diode and an LED.

6. The system in accordance with claim 2 wherein said projectors comprise first and second lenses, each of said lenses being in optical communication with a light guide, and each of the light guides being in optical communication with a light source.

7. The system in accordance with claim 3 wherein said switch means comprises a manually operated system-dedicated switch.

8. The system in accordance with claim 3 wherein said switch means comprises a switch for activation of an unrelated feature but, in addition, automatically operates to activate the system.

9. The system in accordance with claim 3 wherein said switch means includes a switch for activation of the system only at a selected speed and lower speeds.

10. The system in accordance with claim 1 wherein said headlamp assembly comprises right and left headlamps, each of said headlamps being provided with optical surfaces adapted to transmit the first and second beams, respectively, distinct from low beam and high beam light projections.

11. The system in accordance with claim 10 wherein the optical surfaces are disposed in high beam surfaces but direct the first and second beams independently of main high beam light projection patterns.

12. The system in accordance with claim 11 wherein said first and second beams provide a confluence of said first and second beams remote from the main high beam pattern.

13. The system in accordance with claim 12 wherein one of said first and second beams provides a first line pattern and another of said first and second beams provides a second line pattern, and the unitary pattern provides a generally “X” pattern with the first and second line patterns converged and overlying one another.

14. The system in accordance with claim 1 wherein the selected angel is changeable by changing the angular relation between said first and second beams.

15. The system in accordance with claim 11 wherein said optical surfaces are activated by activation of the main high beam light projectors, and remain inactive during inactivation of the main high beam light projectors.
